(19) United States
(12) Patent Application Publication
(10) Pub. No.: US 2013/0009444 A1
(43) Pub. Date: Jan. 10, 2013

(54) SEAT FRAME ATTACHMENT CLAMP AND METHOD

(75) Inventors: Erik C Wilson, Decatur, IN (US); David M. Gerst, Fort Wayne, IN (US); Samuel D Gerst, Woodburn, IN (US); Patrick E Temple, Wapakoneta, OH (US)

(73) Assignee: International Truck Intellectual Property Company, LLC, Lisle, IL (US)

(21) Appl. No.: 13/636,985

(22) PCT Filed: Mar. 25, 2010
(86) PCT No.: PCT/US10/28611

§ 371 Date: Sep. 24, 2012

(51) Int. Cl. A47C 7/00; B23P 11/00

(52) U.S. Cl. 297/463.1; 29/428

(57) ABSTRACT

A clamp for attaching a leg of a seat back sub-frame to a lower sub-frame of a bus seat includes a generally U-shaped body defining a receiving channel generally corresponding in shape to the leg to be received by the body, the body having a web, a first flange and a second flange extending from the web, where the first flange and the second flange are generally parallel. The clamp includes bolt holes some of which are positioned a distance from the web less than and some are greater than width of a rear surface of the leg.

### BACKGROUND

Embodiments described herein relate to seat frames for vehicles. More specifically, embodiments described herein relate to a method and a seat frame attachment clamp for attaching seat sub-frames together to form a seat in a vehicle.

Bus seats are formed by attaching frame members together to form one or more sub-frames, such as a seat back sub-frame and a lower sub-frame. When the sub-frames are assembled to form a seat frame, a seat cushion is attached to the lower sub-frame. The seat frame is typically fixedly attached to the floor of the bus.

Typically, the manufacturer of the seat frame ships the seat frame broken down into the component sub-frames, allowing the customer to assemble the seat frame after delivery. The sub-frames are attached to together at one or more joints to form the seat frame. Prior art joints include the welding of stitch plates to each sub-frame, the welding of the sub-frames to each other directly, the attachment of reinforcing inserts, and the introduction of the sub-frames into a collar and the subsequent bolting of the sub-frames to the collar at multiple locations along the collar.

In addition to maintaining seat frame modularity for shipping, one consideration in the design of the joint is the strength of the joint and/or the weakening of the sub-frames by attaching the joint. Other considerations in the design of the joint are the ability to retrofit existing seat frames in the field, and the cost to manufacture and implement the joint on the seat frame.

### SUMMARY

Embodiments described herein relate to a method and an attachment clamp for attaching a leg of a seat back sub-frame to a lower sub-frame of a bus seat. One embodiment includes a generally U-shaped body defining a receiving channel generally corresponding in shape to the leg to be received by the body, the body having a web, a first flange and a second flange extending from the web, where the first flange and the second flange are generally parallel. The attachment clamp also includes a first bolt hole on the first flange and a corresponding bolt hole on the second flange aligned with the first flange, where the first bolt hole is a first distance from the web that is less than the width of a rear surface of the leg. A second bolt hole is located on the first flange and a corresponding bolt hole is located on the second flange aligned with the first flange, where the second bolt hole is a second distance from the web that is greater than the width of the leg.

Another embodiment provides a method of attaching a leg of a seat back sub-frame to a lower seat sub-frame. In one method,

a seat frame attachment clamp comprising a generally U-shaped body defining a receiving channel generally corresponding in shape to the leg of the seat back sub-frame to be received by the body is provided. The body has a web, a first flange and a second flange extending from the web. The first flange and the second flange are generally parallel. The leg of the seat back sub-frame is located into the receiving channel and between the first flange and the second flange. A first bolt is inserted through the first flange, through the leg and through the second flange. A second bolt is inserted through the first flange, to the side of the leg, and through the second flange.

### BRIEF DESCRIPTION OF THE DRAWINGS

FIG. 1 is a perspective view of a seat frame with a seat frame attachment clamp attaching a seat back sub-frame to a lower sub-frame.

FIG. 2 is a detail perspective view of the seat frame attachment clamp attaching the seat back sub-frame to the lower sub-frame.

### DETAILED DESCRIPTION

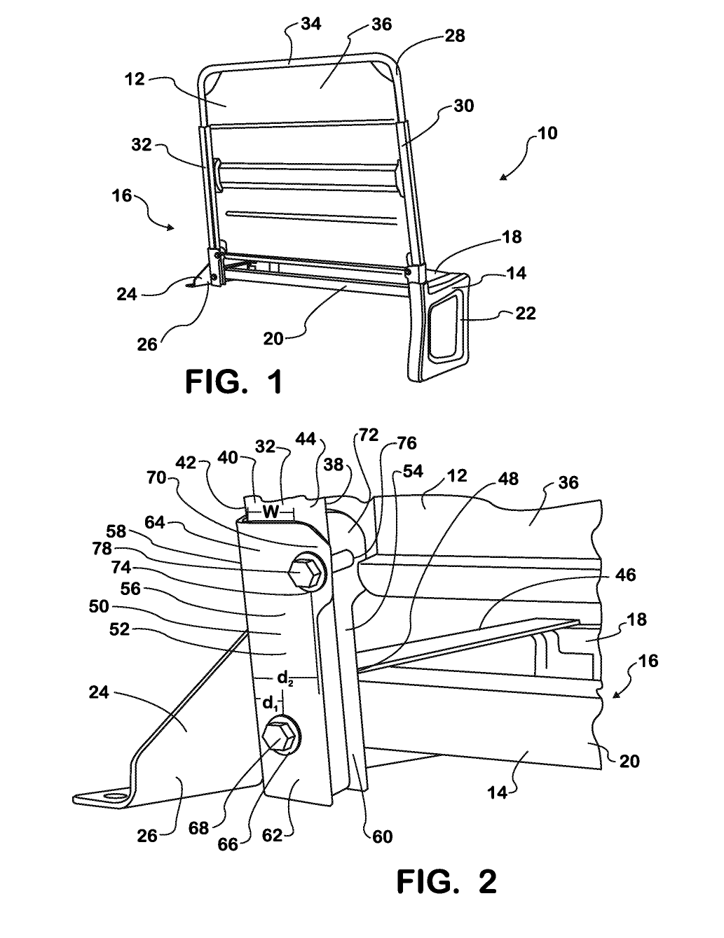

Referring now to FIGS. 1-2, a seat for use in a bus is indicated generally at 10, and is formed by attaching frame members together to form one or more sub-frames, such as a seat back sub-frame 12 and a lower sub-frame 14. When the sub-frames 12, 14 are assembled to form a seat frame, indicated generally at 16, a seat cushion (not shown) is attached to the seat frame to form a bus seat 10.

The lower sub-frame 14 may include a front cross member 18 and a rear cross member 20 that extend between a first seat riser 22 and a second seat riser 24. One or both of the seat risers 22 may be attached to a floor or wall of the bus (not shown). The front cross member 18 and the rear cross member 20 may extend from at least one of the seat risers 22 generally perpendicularly from the seat riser, to the opposite seat riser 24. As seen in FIG. 2, the seat riser 24 has an abutting surface 26 that receives the front cross member 18 and the rear cross member 20.

The seat back sub-frame 12 includes a frame loop 28 having a first leg 30 at a first end, a second leg 32 at a second end, and a third leg 34 generally perpendicularly extending between the first leg and the second leg. A generally planar back support member 36 may extend between the first leg 30, the second leg 32 and the third leg 34. The first leg 30 and the second leg 32 may have a rectangular prismatic shape, however other shapes are contemplated. In the rectangular shape, the first leg 30 and the second leg 32 may have a front surface 38, a rear surface 40 opposite the front surface, an abutting surface 42, and an interior surface 44 opposite the abutting surface.

The seat riser 24 may include a flange 46 that extends generally perpendicularly from the abutting surface 26 of the seat riser, and that extends from the front cross member 20 to the rear cross member 22. At the rear cross member 22, the flange 46 has an edge 48 that is perpendicular to both the flange and to the abutting surface 26.

The frame loop 28 of the seat back sub-frame 12 is joined to the lower seat frame 14 at a seat frame attachment clamp 50. The seat frame attachment clamp 50 has a generally U-shaped body 52 configured to receive the first leg 30 or the second leg 32 of the seat back sub-frame 12. The body 52 has a front flange 54, a rear flange 56 opposite the front flange, and an abutting web 58, the flanges 54, 56 and web 58 defining a receiving channel 60 that generally corresponds to the dimensions of the first leg 30 or the second leg 32. The body 52 is generally open opposite the abutting web 58 for receiving the first leg 30 or the second leg 32 into the seat frame attachment clamp 50. When the leg 30, 32 is received in the receiving channel 60, the leg may abut the web 58 and flanges 54, 56.

The body 52 is generally elongate having a lower portion 62 and an upper portion 64. The lower portion 62 includes a first bolt hole 66 at the rear surface 40, and a corresponding bolt hole (not shown) aligned with the first bolt hole at the front surface 38. The leg 30, 32 also has a corresponding bolt hole (not shown) that is configured to be aligned with the first bolt hole 66 and the second bolt hole of the body 52.

A bolt 68 is introduced into the first bolt hole 66 in the rear surface 40, through the bolt hole in the leg 30, 32, and through the bolt hole in the front surface 38. The bolt 68, passing through the leg 30, 32, positively locates the seat back sub-frame 12. It is also possible that the bolt 68 is introduced into through a bolt hole in the rear cross member 20.

The first bolt hole 66 is a first distance d1 from the web 58 that is less than a width w of the leg 30, 32, which may correspond to the width of a rear surface 40 of the leg. While the hole in the leg 30, 32 for receiving bolt 68 may result in decreased strength of the leg at the location corresponding to the lower portion 62 of the attachment clamp 50, the leg is generally less stressed at the lower portion as compared to a location corresponding to the upper portion 64 of the attachment clamp.

At the upper portion 64 of the body 52, the front flange 54 and the rear flange 56 each include a protruding formation 70, 72 extending outwardly from the flanges 54, 56. A second bolt hole 74 is located on the rear protruding formation 70, and a corresponding bolt hole 76 is located on the front protruding formation 72. The second bolt hole 85 is a second distance d2 from the web 58 that is greater than the width w of the rear surface 40 of the leg 30, 32. The distance d2 may be about the width of the flange 54, 56. It is possible that instead of protruding formations 70, 72, that the flanges 54, 56 have sufficient width to provide the distance d2 from the web that is greater than the width of the leg 30, 32.

When the leg 30, 32 is introduced into the body 52, a bolt 78 is introduced into the second bolt hole 74 and received into the corresponding bolt hole 76. There is no corresponding hole in the leg 30, 32 of the seat back sub-frame, and the bolt 78 is not introduced into the leg. Instead of introducing the bolt 78 through the leg 30, 32, the bolt extends to the side of the leg. The leg 30, 32 is secured in a clamp-configuration between the flanges 54, 56. The lack of a hole through the leg 30, 32 results in decreased stress on the leg at the location that corresponds to the upper portion 64 of the attachment clamp 50.

The protruding formations 70, 72 may be coplanar with the front surface 38 and the rear surface 40 of the body 52, such that the protruding formations are generally parallel. Alternately, it is possible that protruding formations 70, 72 may extend at an angle from the front surface 38 and the rear surface 40 of the body 52, such that the protruding formations extend away from each other. In this non-parallel configuration, the protruding formations 70, 72 form a tapering guide for inserting the leg 30, 32 into the body 52 of the seat frame attachment clamp 50.

Upon fastening the bolt 78 to the upper portion 64 of the body 52, the protruding formations 70, 72 may be moved to a parallel position. Alternately, the protruding formations 70, 72 may be positioned to extend towards each other.

The seat frame attachment clamp 50 is attached to the lower sub-frame 14. The seat frame attachment clamp 50 may abut the edge 48 of the riser flange 46, and also abut the abutting surface 26 of the riser 24. Further, the seat frame attachment clamp 50 may abut the rear cross member 20. Bolts, welds or other fasteners can be used to attach the body 52 to the seat riser 24, the rear cross member 20, or any other portion of the lower sub-frame 14. It is also possible that the attachment clamp 50 is integrally formed with the lower sub-frame 14.

What is claimed is:

1. An attachment clamp for attaching a leg of a seat back sub-frame to a lower sub-frame of a bus seat, the attachment clamp comprising:
a generally U-shaped body defining a receiving channel generally corresponding in shape to the leg to be received by the body, the body having a web, a first flange and a second flange extending from the web, wherein the first flange and the second flange are generally parallel;
a first bolt hole on the first flange and a corresponding bolt hole on the second flange aligned with the first flange, wherein the first bolt hole is a first distance from the web that is less than the width of the leg; and
a second bolt hole on the first flange and a corresponding bolt hole on the second flange aligned with the first flange, wherein the second bolt hole is a second distance from the web that is greater than the width of the leg.

2. The attachment clamp of claim 1 wherein the body is attached to the lower sub-frame.

3. The attachment clamp of claim 1 further comprising a first protruding formation on the first flange, and a second protruding formation on the second flange, wherein the first and second protruding formations each have a second bolt hole configured to receive a bolt.

4. The attachment clamp of claim 3 further comprising a lower portion of the body and an upper portion of the body, wherein the first and second protruding formations are located on the upper portion of the body.

5. The attachment clamp of claim 3 wherein the first protruding formation and the second protruding formation are generally parallel before receiving the bolt.

6. The attachment clamp of claim 3 wherein the first protruding formation and the second protruding formation extend generally away from each other before receiving the bolt.

7. The attachment clamp of claim 3 wherein the first protruding formation and the second protruding formation are generally parallel after receiving the bolt.

8. The attachment clamp of claim 3 wherein the first protruding formation and the second protruding formation extend generally towards each other after receiving the bolt.

9. The attachment clamp of claim 1 wherein the web and the first flange are configured to abut the lower sub-frame.

10. A method of attaching a leg of a seat back sub-frame to a lower seat sub-frame, the method comprising the steps of:
providing a seat frame attachment clamp comprising a generally U-shaped body defining a receiving channel generally corresponding in shape to the leg of the seat back sub-frame to be received by the body, the body having a web, a first flange and a second flange extending from the web, wherein the first flange and the second flange are generally parallel;
locating the leg of the seat back sub-frame into the receiving channel and between the first flange and the second flange;
inserting a first bolt through the first flange, through the leg and through the second flange; and
inserting a second bolt through the first flange, to the side of the leg, and through the second flange.

11. The method of claim 10 further comprising the step of abutting the abutting surface of the leg with the web of the body.

12. The method of claim 10 further comprising the step of attaching the body to the lower seat sub-frame.

13. The method of claim 10 further comprising the step of positioning the first flange and the second flange to extend toward each other after inserting the second bolt.

14. The method of claim 10 wherein the first flange includes a first protruding formation, and the second flange includes a second protruding formation, wherein the first and second protruding formations extend away from each other, and wherein the step of locating the leg into the receiving channel further comprises the step of introducing the leg between the first protruding formation and the second protruding formation.

15. An attachment clamp for attaching a leg of a seat back sub-frame to a lower sub-frame of a bus seat, the attachment clamp comprising:
a generally U-shaped body attached to the lower sub-frame and defining a receiving channel generally corresponding in shape to the leg to be received by the body, the body having a web, a first flange and a second flange extending from the web, wherein the first flange and the second flange are generally parallel;
a first bolt hole on the first flange and a corresponding bolt hole on the second flange aligned with the first flange;
a first protruding formation extending outwardly from the first flange and a second protruding formation extending outwardly from the second flange; and
a second bolt hole on the first protruding formation and a corresponding bolt hole on the second protruding formation aligned with the second bolt hole, wherein the second bolt hole is a greater distance from the web than the first bolt hole.

16. The attachment clamp of claim 16 wherein the first bolt hole is a first distance from the web that is less than the width of a rear surface of the leg, and the second bolt hole is a second distance from the web that is greater than the width of the rear surface of the leg.

18. The attachment clamp of claim 16 further comprising a lower portion of the body and an upper portion of the body, wherein the first and second protruding formations are located on the upper portion of the body.

19. The attachment clamp of claim 16 wherein the first protruding formation and the second protruding formation extend generally away from each other before receiving the bolt.

20. The attachment clamp of claim 16 wherein the web and the first flange are configured to abut the lower sub-frame.
